(19) United States
(12) Patent Application Publication
(10) Pub. No.: US 2005/0039115 A1
(43) Pub. Date: Feb. 17, 2005

(54) Electronic document management system for the construction industry

(75) Inventors: Bruce Gordon, Laguna Niguel, CA (US); Susan Asato, Aliso Viejo, CA (US); Tim Bui, Orange, CA (US); Daniel Clemmons, Garden Grove, CA (US); Johnny Clemmons, Mission Viejo, CA (US); Hakim Khalil, Fullerton, CA (US)

Correspondence Address: KNOBBE MARTENS OLSON & BEAR LLP, 2040 MAIN STREET, FOURTEENTH FLOOR, IRVINE, CA, 92614, US

(73) Assignees: MyWebTeam; Gordon & Williams

(21) Appl. No.: 10/790,438

(22) Filed: Feb. 27, 2004

Related U.S. Application Data
(60) Provisional application No. 60/494,313, filed on Aug. 11, 2003.

(51) Int. Cl. G06F 17/60

(52) U.S. Cl. 715/505

(57) ABSTRACT

Embodiments of the invention include a document management system for the construction industry that organizes projects into accessible documents in an online computer network, such as the Internet, or computer readable media, such as an optical disk or other media. In one embodiment, the system includes a software utility for generating job-specific websites. Subcontractors, vendors, and the like, accessing the website can gather information useful in the submission of construction bids to the general contractor for all or a portion of the construction.

### REFERENCE TO RELATED APPLICATION

This application claims the benefit of U.S. Provisional Application No. 60/494,313, filed Aug. 11, 2003. The present application incorporates the foregoing disclosure herein by reference.

### BACKGROUND OF THE INVENTION

1. Field of the Invention

The invention relates generally to a document management system which provides efficient information distribution from, for example, a general contractor to one or more subcontractors in the construction industry.

2. Description of the Related Art

The construction industry is commonly composed of interlocking hierarchies of owners, architects, developers, construction managers, general contractors, contractors, subcontractors, suppliers and vendors. In order to function, plans, specifications, and project specific information are transferred so that bids and proposals can be submitted. Typically, the general contractor receives documentation from owners, architects, developers, construction managers, and the like, for distribution to contractors, subcontractors, suppliers, vendors, and the like. The collective group of entities, such as contractors, subcontractors, suppliers, vendors, and the like, which utilize plans and specifications to produce bids and proposals for construction jobs will hereinafter be referred to as subcontractors, which is a broad term that should be given its ordinary meaning in addition to the foregoing.

The general contractor typically receives information used to build a construction project from owners, architects, developers, or construction managers in a paper format. The information comprises large format drawings, schematics, specifications, local building ordinances, soils reports, other requirements of the construction job, and the like. Some of the information can pertain to general aspects of the construction task. Other information can pertain to trade specific construction tasks, such as the civil, landscape, demolition, architectural, structural, mechanical, fire protection, plumbing, electrical, security, fire alarm, instrumentation, communication, and the like tasks. One method of distributing the documentation is to reproduce the paper documentation and then send hard copies of the drawings, specifications, and any other information useful in creating a construction bid to the subcontractors.

Obstacles to distributing the documentation include the time and cost burden of often voluminous paper and administrative tasks involved in giving each entity sufficient and appropriate construction job information usable to bid on and/or perform the desired tasks or supply the required material and equipment. In large construction jobs, hundreds of pages of information must flow to multiple dozens of contractors, subcontractors, suppliers, and vendors. Even a small construction job may be sent out to dozens of bidders, which can involve hundreds of sheets of drawings.

To alleviate the burden of reproducing and distributing paper drawings and specifications to the subcontractors, some general contractors send the paper documents to a scanning company and receive from the scanning company the documentation in a digital file format. The digital file format is, for example, a tagged image file format (.tif file) or a portable document format file (.pdf file). The scanning company creates files names for the digital document, which are files applicable to the scanning company's applications. The file names differentiate one file from the next, often numerically, and thus do not convey any indication of the information within the file. Thus, the file names are generally not meaningful to the general contractor, or the subcontractors who consult the documentation prior to submitting bids, proposals, or use them to perform the actual construction work. In some cases, general contractors may collect the digitally formatted documentation and burn a compact disc for subsequent distribution to the subcontractors and vendors. Again, on a compact disc, the file content is not distinguishable by numeric file name.

To increase availability of the construction job documentation, some general contractors manually create a website using an integrated web design tool. An example of an integrated web design tool is Dreamweaver®. The general contractor programs the documentation structure for each construction job through the web design tool, and publishes the completed information on public computer communications network, such as the World Wide Web. At the website, the subcontractors review and order documentation related to a construction task within their area or construction specialty.

It is an inefficient, lengthy and cumbersome task to manually program the documentation structure for each construction job. Often personnel unskilled in computer programming make errors, which cause delay and frustration.

Thus, a general contractor may outsource such services for creating and maintaining a web service for project document access. However, outsourcing generally includes one or more strategic alliances with a third parties, thus leading to additional cost and complication for information transfer, updates, amendments, addenda, and the like. Also, the bidding and building of projects can be extremely time sensitive. In such cases, extended time is often taken because the process used for information transfer is cumbersome, regardless of whether the information transfer is performed internally or outsourced. Such delay is often expensive and counter productive.

### SUMMARY OF THE INVENTION

Accordingly, the construction industry in general, and general contractors specifically, desire a document management system that provides for the efficient and straightforward creation of project-based online information. In one embodiment, the management system may avoid third party reliance, and/or may also allow personnel, who may have very limited computer skills, to create, amend, manipulate, and otherwise interact with the documents of the document management system.

Based on the foregoing, embodiments of the present invention include a unique system and method of creating and organizing a document management system that imparts flexibility to the process of, and reduces the time, overhead, and errors normally expended in, arranging a document management system for the construction industry. According to an embodiment, the document management system may include software instructions that guide a user through the creation of a project-based website and the assignment of documents thereto. Moreover, the system may include user interfaces that guide a user in changing the documents or subject matter posted on the website, such as, for example, guiding a user through updating, amending, adding, and/or deleting subject matter or entire documents, and the like.

According to one embodiment, the user may create a wide variety of organizational structures for organizing, storing, retrieving, updating, and/or modifying documents. For example, the user may store information or documents in an organizational tree structure representing, for example, the sections of one or more books, one or more groups of forms, or the like. Additionally, in other embodiments, the document management system may be configurable to a wide variety of useful organizational structures tailored to needs of specific industries and/or specific users. For example, a management company or health care provider may configure the management system to store documents such as forms in a manner that matches governmental or other provider programs. The document management system may advantageously include a user interface that allows non-skilled users to straightforwardly update or modify the documents or forms stored, or even the structure with which the documents or forms are organized.

An embodiment of the system utilizes end-users' computer systems, hard drives and/or file servers, for processing, storage, and retrieval capabilities connected to a keyboard/display terminal. For example, a software utility or subprogram presents a prompting screen to a user desiring to create a document management system. The user may enter construction job information and category information into the system. The user also can select disciplines to be included in the system. Using some or all of the foregoing information, the software utility creates the appropriate organizational structure for storage and management of the electronic documents. For example, the software utility may create a directory or folder structure, or the like.

The user may also import documents into the structure. In an embodiment, the user can change one or more of the document attributes during the import process. For example, the document name can be modified to names useful and relevant to the industry, user, or the like. After the documents are imported to the document management system, the project utility prompts the user to assign the imported documents to, for example, the categories and disciplines selected in the document management system.

In an embodiment, the user can export the newly created organizational structure and associated documents to an international public computer communications network, such as the World Wide Web, where the construction job information is accessible. Subcontractors, vendors, and the like, access the website to gather information necessary to submit construction bids or update existing accounts to the general contractor.

In an embodiment, the user can also or otherwise export the newly created organizational structure and associated documents to a computer readable medium, such as CD-ROM. The CD-ROM can be sent to subcontractors, vendors, and the like, for the purpose of soliciting construction bids. In an embodiment, the CD-ROM contains the user interface, or the look and feel of the Web page to allow timely and efficient access to documents stored on it.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 illustrates a simplified block diagram illustrating an embodiment of a general contractor system prior to execution of a software utility.

FIG. 2 illustrates a simplified block diagram illustrating an embodiment of a general contractor document management system after execution of a software utility.

FIG. 3 illustrates a flow diagram of an embodiment of software operations performed in generating a general contractor construction job-based document distribution/management system.

FIG. 4 illustrates an embodiment of a new project creation process.

FIG. 5 illustrates an exemplary screen shot of an embodiment of a new project screen.

FIG. 6 illustrates an exemplary screen shot of an embodiment of a document category screen.

FIG. 7 illustrates an exemplary screen shot of an embodiment of a specification section screen.

FIG. 8 illustrates an exemplary screen shot of an embodiment of a drawing discipline screen.

FIG. 9 illustrates one embodiment of an import documents process.

FIG. 10 illustrates one embodiment of an assign documents process.

FIG. 11 illustrates an exemplary screen shot of an embodiment of a document assignment screen.

FIG. 12 illustrates an exemplary screen shot of an embodiment of a setup parameters screen.

### DETAILED DESCRIPTION OF THE PREFERRED EMBODIMENT

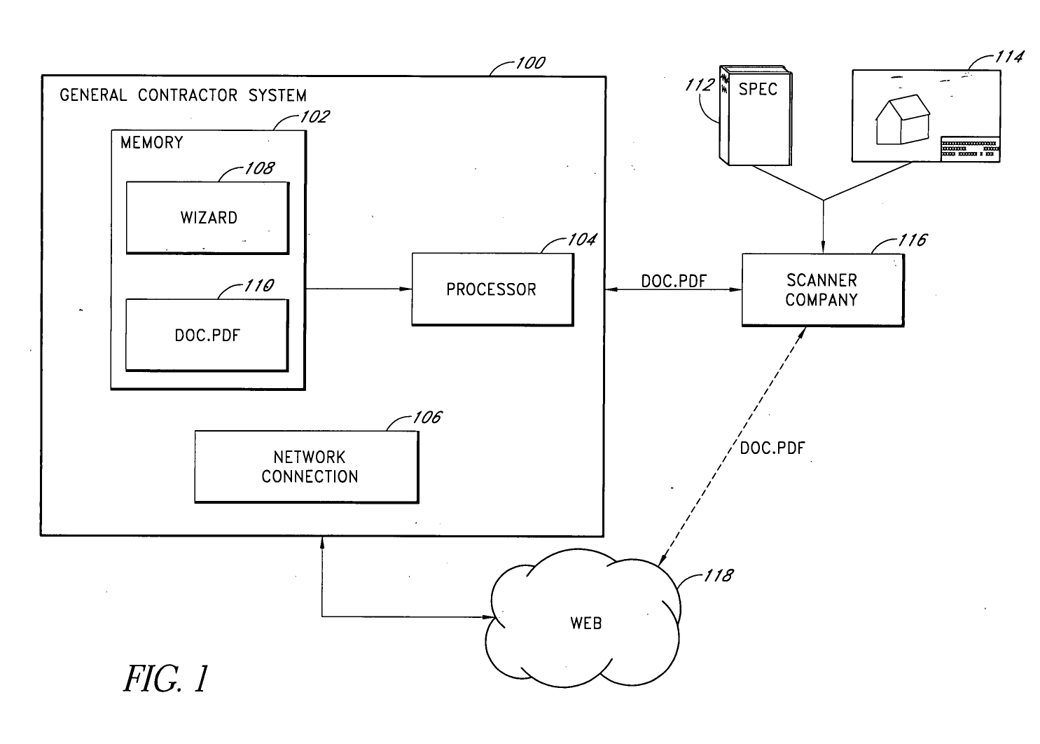

For a more detailed understanding of the invention, reference is first made to FIG. 1. FIG. 1 illustrates an exemplary general contractor system prior to execution of a software utility according to an embodiment of the invention. A general contractor system 100 comprises a memory 102, a processor 104, and a network connection 106. The memory further comprises a software utility such as a wizard 108, and one or likely many stored construction documentation and drawing files 110.

The processor 104 comprises, by way of example, processors, program logic, or other substrate configurations representing data and instructions, which operate as described herein. In other embodiments, the processors can comprise controller circuitry, processor circuitry, processors, general purpose single-chip or multi-chip microprocessors, digital signal processors, embedded microprocessors, microcontrollers and the like.

In one embodiment, the software utility 108 may advantageously be implemented as one or more software modules. The modules may advantageously be configured to execute on one or more processors. The modules may comprise, but are not limited to, any of the following: software or hardware components such as software object-oriented software components, class components and task components, processes methods, functions, attributes, procedures, subroutines, segments of program code, drivers, firmware, microcode, circuitry, data, databases, data structures, tables, arrays, or variables.

In the illustrated embodiment of FIG. 1, the general contractor receives information to build a construction job from the owners, architects, developers, construction managers and the like, generally in a paper format. In one embodiment, the general contractor sends paper construction documents 112 and drawings 114 to a scanner company 116. The scanner company 116 creates electronic file versions of the paper documents 112 and drawings 114. In one embodiment, the scanner company 116 sends the electronic files to the general contractor system 100. In another embodiment, the general contractor obtains the electronic files from the scanner company 116. In another embodiment, some or all of the communication between the general contractor system 100 and the scanner company is 116 through a communication medium 118, such as the Internet, as indicated by the dashed line in FIG. 1. The electronic files are stored in the computer accessible memory in the general contractor system 100, such as the memory 102.

The network connection 106 comprises any device that allows the general contractor system 100 to communicate with the communication medium 118 and/or the scanner company 116. Typically the network connection 106 comprises a conventional modem, cable modem, a DSL (Digital Subscriber Line), an ISDN (Integrated Services Digital Network) modem, and the like. Network connections are also possible via wireless communications systems such as, but not limited to, a cellular phone or cellular palmtop connection, Bluetooth technology, and the like.

In one embodiment, the communication medium 118 comprises an international public computer communications network, such as the World Wide Web. In another embodiment, the communications medium comprises the Internet, which is a global network of computers. In other embodiments, the communications medium can be any communication system including by way of example, dedicated communication lines, telephone networks, wireless data transmission systems, two-way cable systems, customized computer networks, interactive kiosk networks, interactive television networks, and the like.

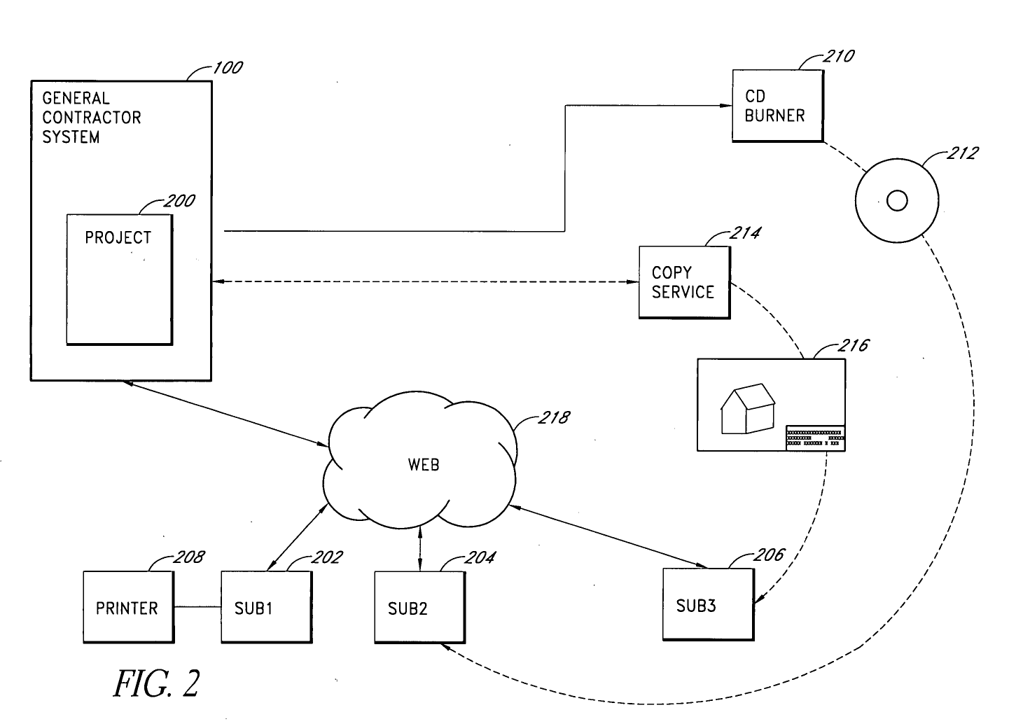

FIG. 2 illustrates the general contractor document management system 100 further comprising a project 200. Execution of the software utility 108 creates one or more projects 200 in the general contractor system 100. In another embodiment, the software utility 108 creates the project 200 in other computer systems or websites, such as those managed by a third party or the like. The user supplies the software utility 108 with project information, category selections, discipline selections, document assignments, and setup parameters. The software utility 108 then creates each project 200.

In an embodiment focused on the construction or similar industry, the project 200 comprises specifications, addenda, drawings, and the like, organized in a hierarchical structure folder or directory. In an embodiment, the project 200 corresponds to a specific construction job for which the general contractor is soliciting construction bids or managing ongoing work from the subcontractors, vendors, and the like. Thus, for each construction job, the general contractor may generate the project 200. In other embodiments, the project 200 may include several or all construction jobs.

The software utility 108 also can create a construction project document management website, which permits communication with the project 200 through the communication medium 118. The software utility 108 may also create a construction project document management CD-ROM or other computer readable storage media as will be disclosed in further detail below.

FIG. 2 further illustrates three exemplary subcontractors 202, 204, and 206, communicating with the project 200 through the communication medium 118. Subcontractor 202 accesses the construction project document management website, downloads applicable PDF files, and prints on printer 208 selected construction documentation at subcontractor 202. Subcontractor 204 accesses and views the construction project document management website but is unable to print the construction documentation. Through the project website, subcontractor 204 requests all or a portion of the construction project information. The general contractor exports the requested construction project information to a CD-ROM burner 210. Subcontractor 204 receives the requested construction project information on a CD-ROM 212.

Subcontractor 206 accesses the construction project document management website but is also unable to print construction documentation. Through the project website, subcontractor 206 requests all or a portion of the construction project information. The general contractor exports the requested construction project information to a copy service 214. The copy service 214 may be a part of the general contractor or may be an outside service. Subcontractor 206 receives the requested construction project information 216 from the copy service 214. In another embodiment, subcontractors who are unable to print but want paper copies of one or more documents, may place an order for the documents through the general contractor who may fill the order directly or outsource the order, as discussed in the foregoing.

The cost of the document may be calculated based on the document size, such as the number of square inches of the document area. In an embodiment, the document size comprises the document area calculated from the actual length and width of the original document. In another embodiment, the project 200 determines the closest standard document size to the actual document size. The project 200 calculates the document area, and thus the reproduction cost, based on the closest standard document size to the ordered document. Although disclosed with reference to preferred and alternate embodiments, an artisan will recognize from the disclosure herein a number of price determination methodologies for pricing documents ordered, such as, for example, price per unit measured, per closest standard unit, per page, per document type, per payment type, per printing device, or the like.

In an embodiment focussed away from the construction industry, the project 200 can include pages of a book or manual, forms, instructions, or the like for a specific industry or project, purchase orders, other business or commercial documentation or order solicitation, fulfillment or the like. The project 200 can advantageously organize the foregoing information into virtually any organizational structure by allowing a user to designate the structure and assign documents thereto.

Users of the project 200 may print, order, and access the information similar to that described in the foregoing.

In an embodiment, the general contractor document distribution/management system 100 comprises one or more associated websites or web pages on the World Wide Web. In other embodiments, the general contractor document distribution/management system 100 comprises any device that interacts with or provides data to the end-user computer, including by way of example, any internet site, private networks, network servers, video delivery systems, audio-visual media providers, television programming providers, telephone switching networks, teller networks, wireless communication centers and the like. The end-user comprises subcontractors, vendors, and other entities desiring to access the general contractor construction job information. Typically, the end-user accesses the general contractor construction job information to retrieve information used in submitting a construction bid or for coordination of on going projects for all or a portion of the construction task.

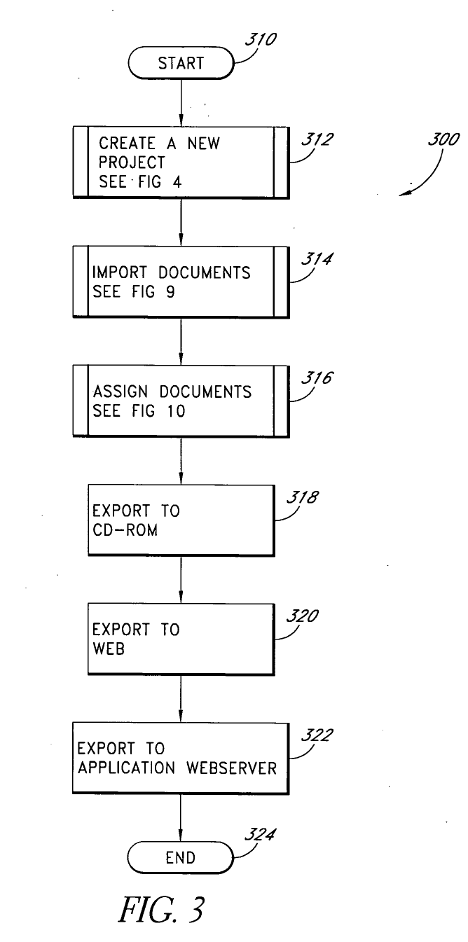

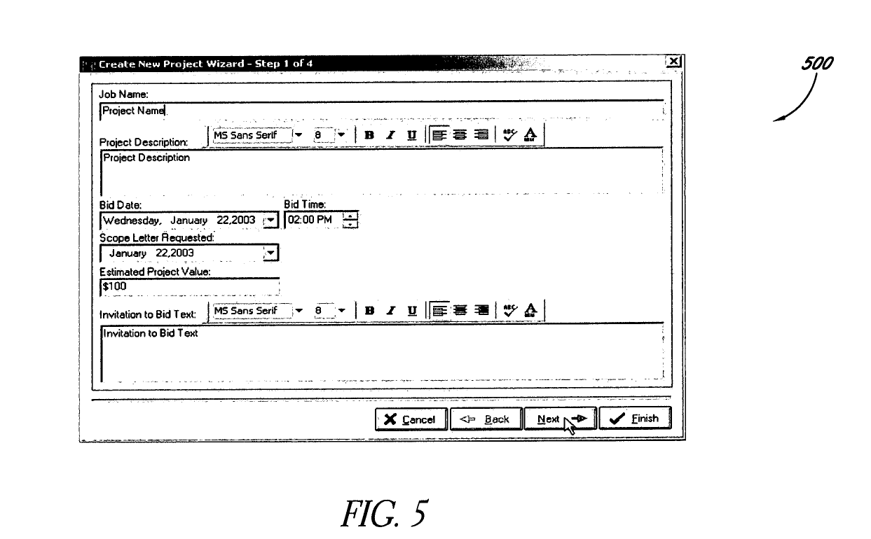

FIG. 3 illustrates a flow diagram of an embodiment of a document management system generation process 300 generated by, for example, the software utility program 108 of FIG. 1. In an embodiment, the generation process 300 assembles the screens of FIGS. 5-8, 11, and 12, and processes the user-entered data. In block 310, the user initiates the process of creating a new project. The software utility 108 calls the prompting screens 500, 600, 700, and 800 depicted in FIGS. 5-7, and 8, respectively. The user enters the prompted data and makes the prompted selections. In block 312, the software utility 108 creates a new project 200. In block 314, the software utility 108 imports the documents into the project 200.

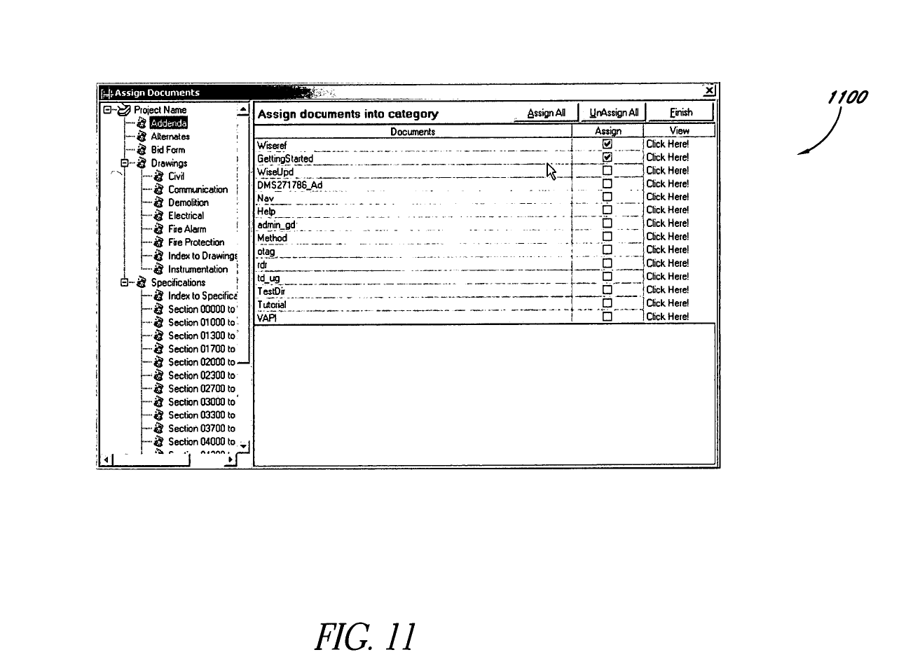

The software utility 108 calls the assign documents prompting screen 1100, as depicted in FIG. 11. The user assigns the documents to divisions such as categories and disciplines. The software utility 108 updates the project file to reflect the assignments the user made, as indicated by block 316.

When desired, in block 318, the software utility 108 exports the project 200 so that the project 200 can be burned onto a CD-ROM. The software utility 108 exports the files associated with the project 200 to a folder where the folder can be burned onto a CD by an external application. The software utility 108 also creates the appropriate interface so users of the CD-ROM are able to link to the files.

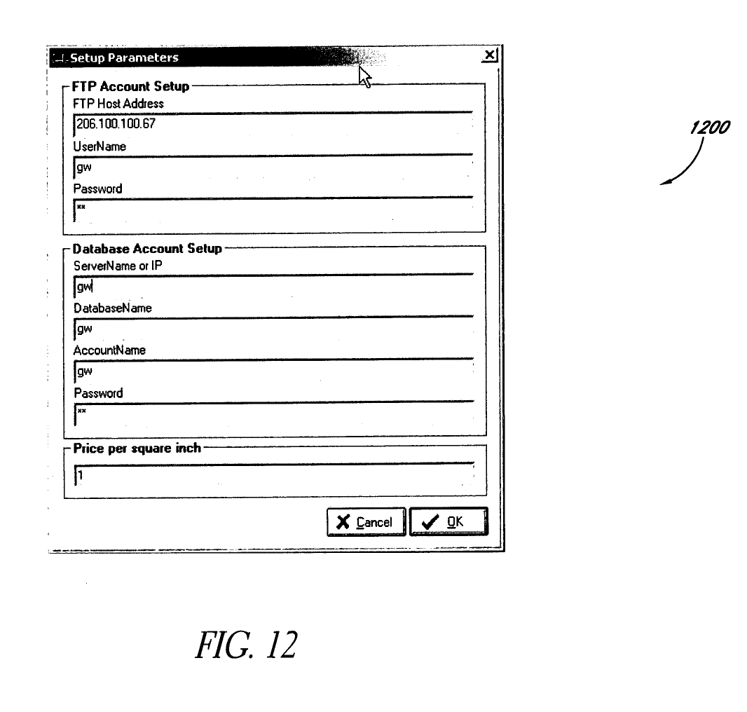

Also when desired, in block 320, the software utility 108 exports the project 200 to the World Wide Web. The software utility 108 calls the setup parameters prompting screen 1200, depicted in FIG. 12. The user enters the prompted setup parameters and the software utility 108 connects to the Web server with the FTP (File Transfer Protocol) account information and the Database account information. Further, the software utility 108 uploads the documents to the FTP information and creates appropriate data into the database.

Also when desired, in block 322, the software utility 108 exports the project 200 to a secure applications Web server to control access to the data. The software utility 108 calls the setup parameters prompting screen 1200, depicted in FIG. 12. The user enters the prompted setup parameters and the software utility 108 connects to the applications Web server, using, for example, the FTP (File Transfer Protocol) account information and the Database account information. Further, the software utility 108 uploads the documents to a secure area and uploads the file metadata to an applications program. Examples of metadata comprise the file name, the category, the project name, and the like. The applications program has rules for accessing the data. The applications program displays the data to users who have satisfied the rules. Typically, the data in the secure area is available to users with the validated password. For example, the construction schematics for a bank would only be available to pre-approved users with a valid password. Other advantages of the secure area may include automatically printing user-selected documents to a printing device, and ordering and paying for user-selected documents. The project utility program logic ends at block 324.

In an embodiment, one or more similar processes can be used to update or change the documents or subject matter stored in the project 200. In other embodiments, other user interfaces can present straightforward steps for updating, changing, deleting, or the like within the project 200 after the project's initial generation.

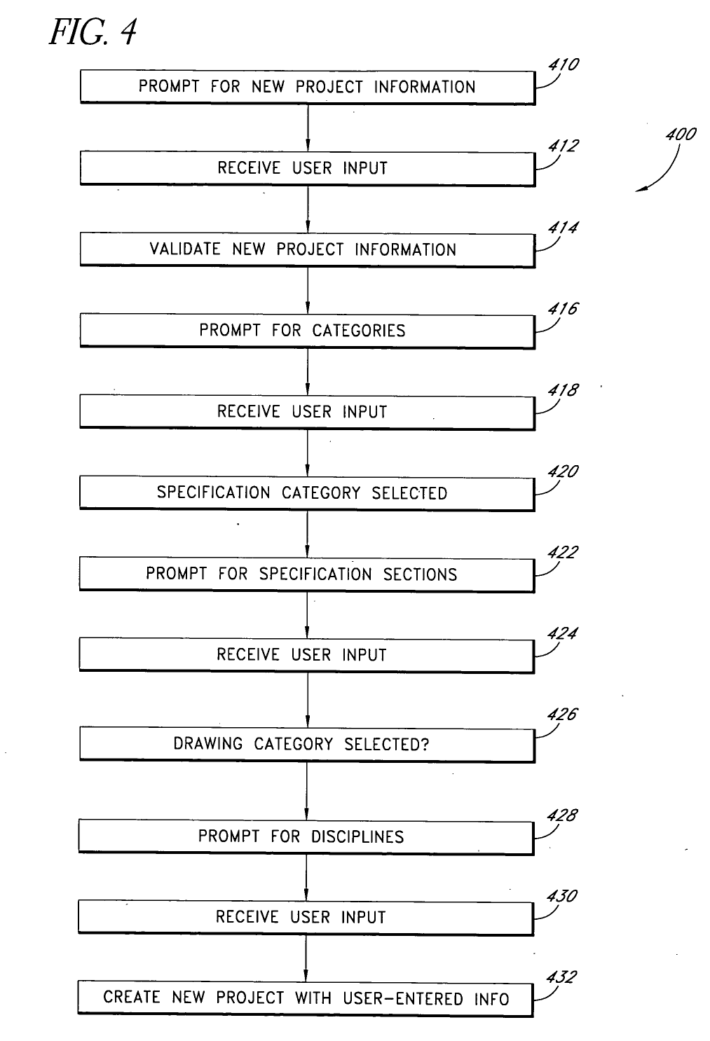

FIG. 4 illustrates in further detail a new project creation process 400 used, for example, to create a new project for the generation process 300 of FIG. 3. In block 410, the software utility 108 prompts the user for new project information, as depicted in FIG. 5.

FIG. 5 depicts an exemplary screen shot of an embodiment of a new project screen 500 of a software application for creating a general contractor job-based or project-based document management system 100. The initial screen 500 is presented to a user to create each document management system for each project. The user enters information such as the information described in the foregoing utilized in creating the new project 200. For example, new project information may comprise construction job name, project description, bid date and time, due date, estimated value of the construction job, any comments or requirements for the bid process, and any other general information useful to the bid process for the construction job. Similar fields are used for works in progress or completed work, such as archiving.

Preferably, the user enters information from a keyboard, but the user is not limited to a keyboard as the information entry means. Other entry means comprise voice data entry, scanned data entry, pointer selected entry, and the like. The entry means contemplated is connected via phone line, hard wiring, cell phone, and the like to a general contractor system which processes, stores, and retrieves data associated with a construction job.

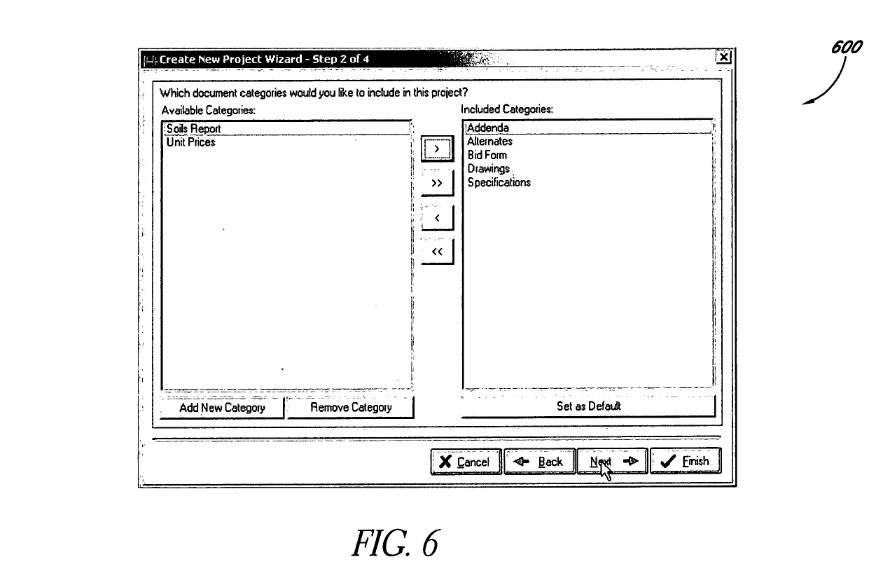

In an embodiment, the software utility 108 also retrieves the new project screen information, as indicated in block 412. The software utility 108 validates the new project information in block 414. In block 416, the software utility 108 prompts the user for category selection by calling the document category screen 600 as depicted in FIG. 6.

FIG. 6 depicts an exemplary screen shot of an embodiment of a document category screen 600 of a software application for creating the document management system 100. The user selects the document categories to include in the project 200, which are often dictated by the type of construction project or other industry standard to which the project 200 will be applied. The user may also create categories not presented by the software utility 108. Examples of document categories for the construction industry include soils report, unit prices, addenda, alternatives, bid form, drawings, specifications, and the like.

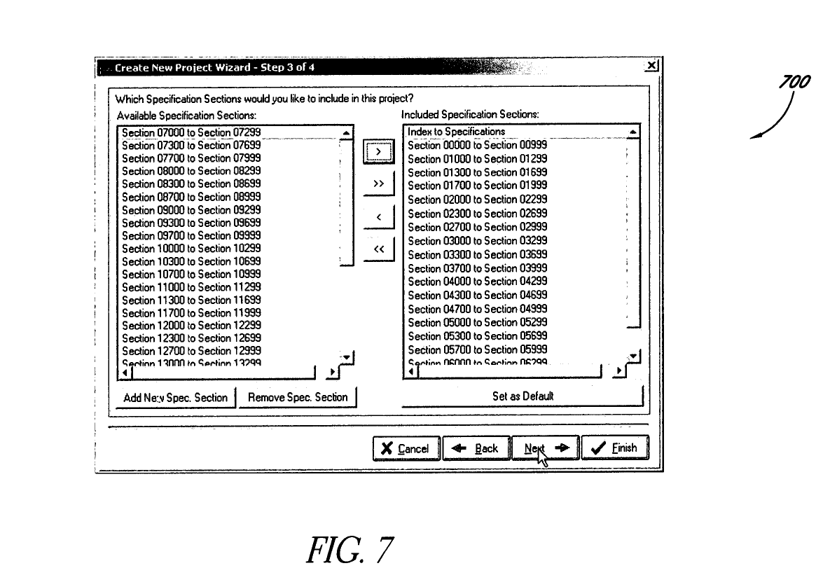

In an embodiment, the software utility 108 also retrieves the document categories, as indicated in block 418. If, in block 420, the user selected the specification category, the software utility 108 in block 422 calls the specification section screen 700, as depicted in FIG. 7.

FIG. 7 depicts an exemplary screen shot of one embodiment of a specification sections screen 700 of a software application for creating a document management system 100 for the construction industry. The user selects the specification sections to include in the project 200. Typically, the specification sections are defined in the specifications contained in a Project Manual book or other information provided for the project. A job or project may include any combination of specification sections, or the user may add a specification section not presented by the software utility 108.

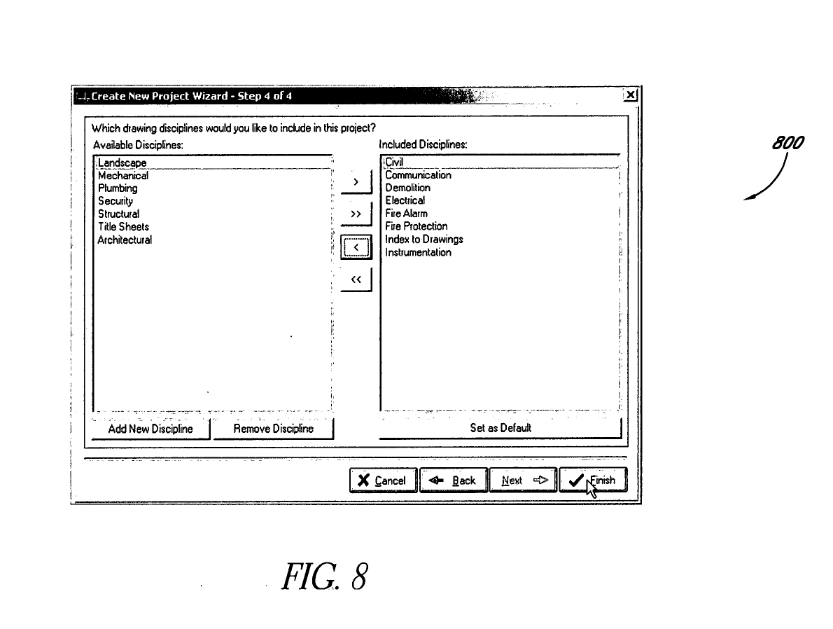

In an embodiment, the software utility 108 also retrieves the specification sections, as indicated in block 424. If, in block 426, the user selected the drawing category, the software utility 108, in block 428, calls the drawing discipline screen 800, depicted in FIG. 8.

FIG. 8 depicts an exemplary screen shot of an embodiment of a drawing discipline screen 800 of a software application for creating the electronic document management system 100. The user-selectable disciplines typically represent the trades or construction tasks that will be used to complete the construction job. Examples of drawing disciplines are architectural, civil, communication, demolition, electrical, fire alarm, fire protection, instrumentation, landscape, mechanical, plumbing, security, structural, and other trades or construction tasks used in the construction job. Additional pertinent documents often include an index to drawings, General Notes, and the like.

The software utility 108 also retrieves the drawing disciplines, as indicated in block 430 and creates a new project 200 with the user-entered information in block 432. For example, according to one embodiment, the project utility 108 uses the gathered data on the new project and may create a hierarchical structure, folder, or directory with the project as the top level. A second level may comprise the user-selected categories. A third level comprises the disciplines, specification sections, and other sub-category groupings. Within the specification category, for example, the third level comprises the specification sections selected by the user. Within the drawings category, for example, third level comprises the user-selected disciplines. However, a user may designate other or more levels, categories, specifications, disciplines, chapter, code sections or virtually any organizational structure.

The project utility 108 prompts the user whether and which documents are to be imported. The project utility 108 imports the documents from the general contractor system storage media. As disclosed, the documents may comprise in the construction industry, drawings, schematics forms, text documents, specifications, codes, ordinances, and the like. Examples of possible imported file formats are pdf (portable document format), ps (postscript), jpeg (joint photographic experts group), png (portable networks graphics), gif (graphics interchange format), png (portable network graphics), pcx (PC paintbrush), tif (tagged image file format), doc (word), and the like. The imported documents are queued in the new project 200 by the software utility 108 without the need for a database software interface. In another embodiment, the imported documents are queued in the new project 200 by the software utility 108 using a database software interface.

In an embodiment, the user can change some of the document attributes before finishing the import process. For example, the document name can be advantageously changed to reflect some or all contents of the document and/or to be recognizable to those that access the documents. For example, the document title as indicated in the drawing title block can be used as the document file name. A preview function can allow the user to view some or all of the changed document or changed document attributes before finishing the import process. Additionally, the document can be modified for compatibility with document reproduction equipment, such as printers, copiers, plotters, and the like.

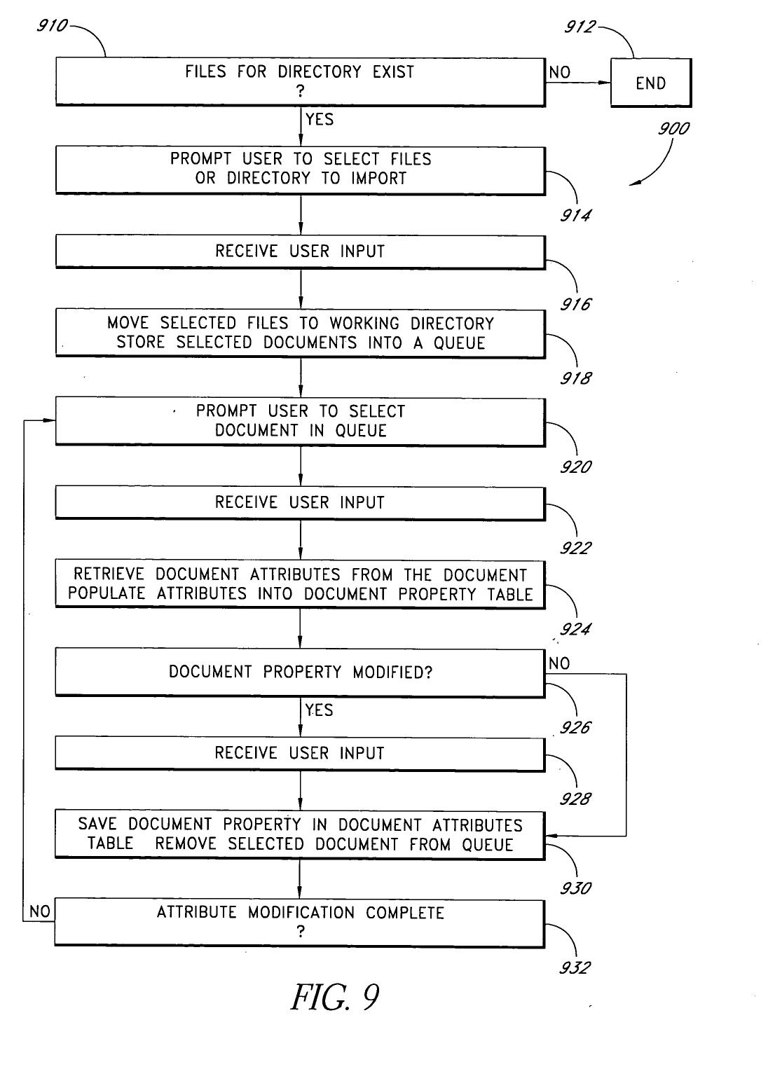

FIG. 9 illustrates in further detail an import documents process 900 used, for example, to import documents for the generation process 300 of FIG. 3. As indicated by block 910, the software utility 108 verifies that files or a directory exist. If no files or directory for the project 200 exist, the software utility 108 does not proceed further, as indicated by block 912. If files or a directory exist, the software utility 108 prompts the user to select files or a directory to import in block 914. The user enters information and the software utility 108 retrieves the information, as indicated in block 916. In block 918, the software utility 108 moves the selected files to a working directory and stores the selected documents in a queue. The software utility 108 prompts the user to select documents from the queue, as indicated in block 920. The user selects the documents to import, and the software utility 108 retrieves the information, as indicated in block 922. In block 924, the software utility 108 retrieves the document attributes and populates the attributes into a document property table. The user is prompted to change the document attributes in block 926. Optionally, a preview function allows the user to view the changed document attributes. If the user modifies the document attributes, for example, the document name, the software utility 108 retrieves the information in block 928. In block 930, the software utility 108 saves the original document attributes or the new document attributes, if the original document attributes are modified, in the document attribute table. Also in block 930, the software utility 108 removes the selected document from the queue. Blocks 920 through 932 are repeated until all of the selected documents are imported, as indicated in block 932.

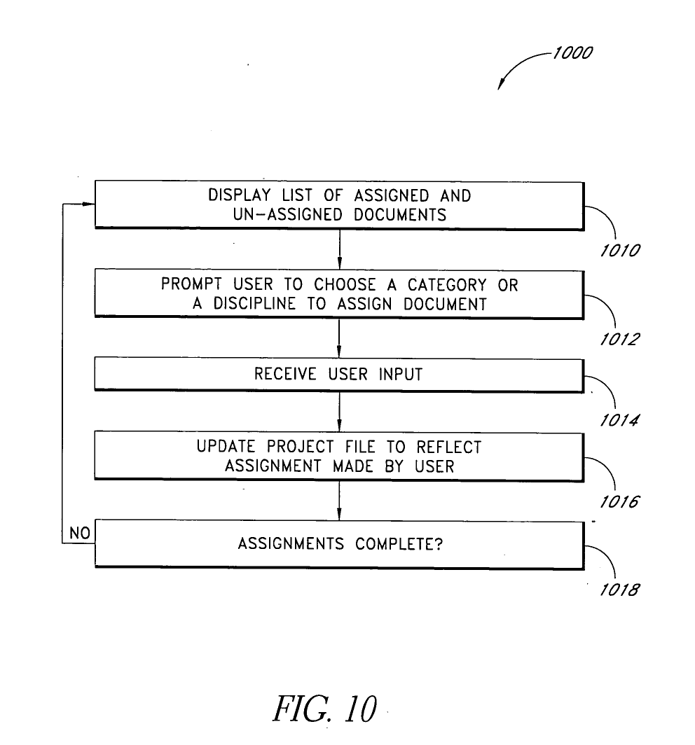

FIG. 10 illustrates in further detail an assign documents process 1000 used, for example, to assign documents for the generation process 300 of FIG. 3. The software utility 108 displays a list of assigned and un-assigned documents in block 1010. In block 1012, the software utility 108 calls the assign documents prompt screen 1100, as depicted in FIG. 11. The user assigns documents and drawings to the divisions, such as the categories and the disciplines. The software utility 108 retrieves the assignments in block 1014. In block 1016, the software utility 108 updates the project file to reflect the assignment made by the user. Blocks 1010 through 1018 repeat until the user assigns all of the selected documents into a category or a discipline, as indicated in block 1018.

In an embodiment, the project utility presents the user with an assign documents screen. FIG. 11 depicts an exemplary screen shot of an embodiment of an assign documents screen 1100 of a software application for creating a general contractor job-based document management system 100. As depicted in FIG. 11, the “Wiseref” and “GettingStarted” documents are assigned to the “Addenda” category. The user assigns the documents to the previously selected categories and disciplines. The user typically assigns the trade or construction task drawings to the respective trade or construction task discipline in the drawing category. For example, the user assigns the electrical schematics to the electrical discipline and the landscape drawings to the landscape discipline in the drawing category. The software utility 108 assigns the selected specification sections to the specification category. The user can also modify the document names in the assign documents screen 1100. Upon completion of assigning the documents to a category or a discipline, the user has the option of creating a general contractor construction job-based website and/or a CD-ROM with the general contractor job-based document management system.

In an embodiment of the invention, the software utility 108 exports the project 200 to a CD-ROM burner. The CD-ROM can be sent to subcontractors, vendors, and the like to provide them with the construction job specific documentation and drawing information needed to bid on all or a portion of the construction. The CD-ROM has the navigation features of a table of contents page with hyperlinks to all project specific categories.

In another embodiment of the invention, the software utility 108 creates a website on the World Wide Web. The software utility 108 prompts the user with a setup parameters screen.

FIG. 12 depicts an exemplary screen shot of an embodiment of a setup parameters screen 1200 of a software application for creating a general contractor job-based document management system 100. In an embodiment, the user enters on the screen 1200 the FTP (File Transfer Protocol) account setup information and the database account setup information. Examples of the FTP account setup information are FTP host address, user name, password, and other information used to create a website location on the World Wide Web. Examples of database account setup information are server name, IP (Internet Protocol), database name, account name, password, and other information used to create a website location on the World Wide Web. In an embodiment, the user enters on screen 1200 the price per square inch used to calculate document reproduction charges. Upon completion of the setup parameters screen 1200, the software utility 108 creates a website on the World Wide Web where subcontractors, vendors, and the like can access construction job specific documentation and drawing information. The website has the navigation features of a table of contents page with hyperlinks to all project specific categories. Using the construction job documentation and drawing information, the subcontractors, vendors, and other interested parties can bid on performing all or a portion of the construction or access the PDF files for use during a project.

According to one embodiment, the system provides a straightforward and reliable method for updating changes to one or more of the electronic documents. For example, when a user has finished making updates, additions, deletions, or other modifications, the user republishes the project 200. Republication effectively reruns the software utility 108, for example, without prompting the user for additional information. By rerunning the utility 108, each file is overwritten, thereby ensuring that all changes are properly published within the online systems, such as, for example, the CD-ROM, the website, or the like. Additionally, various security or accessibility procedures can be implemented to limit the users who can perform republication of some or all of the project 200. Moreover, republication that changes only modified documents can be implemented using a size compare or the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A method of generating a project-based electronic document management system, the method comprising:
importing one or more construction documents in electronic form;
developing an organizational structure;
assigning the one or more construction documents to divisions within the organizational structure; and
automatically generating a project-based electronic document management system including the one or more construction documents organized within the organizational structure and accessible via a computing system.

2. The method of claim 1, wherein the step of importing further comprises modifying properties of the one or more construction documents.

3. The method of claim 2, wherein one of the properties comprises a name, and wherein the modification includes selection of a name recognizable to a user of the project-based document management system.

4. The method of claim 2, wherein one of the properties comprises a digital format of the electronic form and wherein the modification includes format standardization.

5. The method of claim 1, wherein the step of importing comprises importing from a third party vendor.

6. The method of claim 5, wherein the third party vendor comprises a scanning company.

7. The method of claim 1, wherein the one or more construction documents includes construction project information.

8. The method of claim 1, wherein the one or more construction documents includes specification sections.

9. The method of claim 1, wherein the one or more construction documents includes categories.

10. The method of claim 1, wherein the project-based document management system includes disciplines.

11. The method of claim 1, further comprising:
presenting a user with a prompting screen for entering construction project information;
presenting the user with a category screen for selecting categories;
presenting the user with a specification sections screen for selecting specification sections; and
presenting the user with a discipline screen for selecting disciplines.

12. The method of claim 1, wherein the project-based document management system comprises a website and is accessible via the Internet.

13. The method of claim 1, wherein the project-based document management system comprises a CD-ROM and is accessible via a computer.
The method of claim 1, wherein the project-based document management system comprises computer readable storage media.

14. The method of claim 1 further comprising assigning one of a plurality of standard document sizes to the one or more construction documents, wherein an actual document size may not be identically equal to any of the plurality of standard document sizes.

15. A method of creating of a document management system for the construction industry, the method comprising organizing electronic documents by assigning the each electronic document to an organizational structure and modifying one or more of the electronic documents to change a name to be recognizable to general contractors and subcontractors.

16. The method of claim 15, wherein the organizational structure is customizable.

17. A system for generating a construction project-based document management system comprising:
construction documents in a digital file format;
a software utility;
memory storing the construction documents and the software utility; and
a processor which executes the software utility to automatically generate a construction project-based document management system;

18. The system of claim 17, further comprising a network connection, wherein the construction project-based document management system is accessible via a computer network communicating with the network connection.

19. The system of claim 18, wherein the computer network comprises the Internet.

20. The system of claim 17, further comprising a computer readable storage device, wherein the construction project-based document management system is accessible via the computer readable storage device.

21. The system of claim 17, wherein the computer readable storage device comprises a CD-ROM.
